(19) United States
(12) Patent Application Publication
(10) Pub. No.: US 2024/0293866 A1
(43) Pub. Date: Sep. 5, 2024

(54) ADDITIVE MANUFACTURING APPARATUS WITH DECOUPLED PROCESS CHAMBER AND ADDITIVE MANUFACTURING METHOD

(71) Applicant: DMG MORI ADDITIVE GMBH, Bielefeld (DE)

(72) Inventors: Meinolf TEPPER, Rheda-Wiedenbrück (DE); Stefan SCHOEN, Bielefeld (DE); Christian TENBROCK, Rheda-Wiedenbrück (DE); Marc TIMMER, Delbrück (DE)

(73) Assignee: DMG MORI ADDITIVE GMBH, Bielefeld (DE)

(21) Appl. No.: 18/578,515

(22) PCT Filed: Nov. 28, 2022
(86) PCT No.: PCT/EP2022/083441

§ 371 Date: Jan. 11, 2024

(30) Foreign Application Priority Data
May 16, 2022 (DE) 10 2022 112 241.7

(51) Int. Cl. B22F 10/36; B22F 10/28; B22F 12/00; B33Y 10/00; B33Y 30/00; B33Y 50/02

(52) U.S. Cl. CPC B22F 10/36; B22F 10/28; B22F 12/222; B33Y 10/00; B33Y 30/00; B33Y 50/02

(57) ABSTRACT

A manufacturing plant based on optical interaction, in particular a manufacturing plant for selective laser melting. By a special arrangement of the main components of the apparatus, such as the process chamber and the optical module, relative to one another and by means of decoupled bearings and the provision of positioning elements, a particularly high degree of accuracy in component production can be achieved in a simple manner.

The present invention relates to a manufacturing plant that can be automated and is based on optical interaction, in particular a manufacturing plant for selective laser melting (SLM) with an optimized arrangement of the accuracy-determining components so that external interference and interference occurring during the process can be minimized. In addition, an optimized additive manufacturing method is proposed.

SLM systems known in the prior art are constructed in such a way that the individual elements required to produce an SLM component part, such as in particular the optical module, a build chamber, a coater and the Z-axis, are attached directly to the build chamber or directly to each other and to each other.

However, this type of connection has the disadvantage that when the relative position and/or orientation of the elements or the subcomponents in this composite change, in particular due to thermal deformations or due to the effect of force, unwanted changes take place in the overall structure. This leads to deviations and inaccuracies in the manufacture of the component part to be produced. The deformation of the structures of the main components typically causes point positioning errors of the position and orientation of the laser beam in the powder plane, which cannot be reproduced and compensated for or can only be compensated for at very high cost.

In particular, in the case of SLM machines with multiple laser scanner systems, there can also be deviations in the relative positions of the various laser beams in the powder plane. In addition, deviations in the powder bed surface, such as the position or orientation as well as the actual layer thickness, can occur. Thus, the quality of the manufactured component part can be affected, resulting in geometric defects, such as shape and position deviations, reduced surface quality, or metallurgical defects, such as bonding defects or gas porosity.

An apparatus for the production of molded bodies according to the principle of selective laser melting is known, for example, from DE 10 2019 200 680 A1. The subject matter of this application is hereby incorporated by reference.

One object of the present invention is to provide a manufacturing apparatus for additive manufacturing with which an improved manufacturing quality of the component part to be manufactured can be achieved. In addition, it is an object of the invention to provide an optimized manufacturing process with which an improved manufacturing quality can be achieved. In particular, it is an object of the invention to minimize the disturbing factors and disturbing influences occurring during the manufacture of an SLM component part, in particular thermal influences and force influences, so that the quality of the object to be manufactured can be improved.

To solve the objects, the features of the independent claims are proposed. Advantageous embodiments can be found in the dependent claims.

An apparatus for layer-by-layer buildup of objects of powdered material by optical interaction may include a process chamber and at least one optical module. In particular, the apparatus can make use of a selective laser melting process.

The process chamber can be provided to provide a working space at a construction field. At least one optical module can be provided, which is part of an irradiation unit, or which forms an irradiation unit for spatially selective irradiation of the material present in the region of the construction field. Preferably, the optical module is arranged above and spaced-apart from the process chamber. A primary carrier or receiving element can be used to enable a central connection of individual main components of the apparatus. The receiving element or basic element functions as a carrier unit for receiving or supporting the main components of the apparatus or manufacturing plant. Main components comprise in particular those components of the apparatus which are necessary for the production of the object, i.e., in particular one or more optical modules, the process chamber, a coater and a Z-axis and/or lifting apparatus. Advantageously, the at least one optical module is mounted or received on the base element at a first junction. Further advantageously, the process chamber is received or mounted on the base element at a spaced-apart second junction, decoupled from the at least one optical module. Thus, the optical module is arranged separately from the process chamber, whereby the optical module as well as the process chamber are each mounted on the base element.

Thermal expansions of the process chamber thus no longer directly influence the spaced-apart optical module. Since all main components of the apparatus are preferably provided separately and at a distance from each other on the basic element, thermal influence or mechanical influence of the main components on each other is also minimized.

Preferably, the main components are accommodated exclusively on the base element, and particularly preferably the main components are each supported only at one or more junctions provided separately for each of the main components. The main components or accuracy-determining components are therefore arranged in such a way that they do not influence each other or that the influence is kept to a minimum.

Particularly preferably, the process chamber is mounted to the base member via a plurality of junctions, wherein each of the junctions is spaced-apart from the first junction (at which the optical module is mounted), and wherein particularly preferably the plurality of junctions are arranged substantially in a horizontal plane.

Particularly preferably, the basic element has a reference plane with respect to which the main components are arranged and positioned and whose relative position is used as position information, for example to compensate for deformations.

In other words, all relevant components are preferably attached to the basic element and a plane of the apparatus, which is defined as a common reference plane and which is particularly preferably the reference plane of the optical module, is used as the reference plane for each of the individual main components.

By this characteristic arrangement of the main components and in particular the optical module and the process chamber spaced-apart and separated from each other directly on the basic element, so that the thermal and mechanical influence of these components can be minimized, the manufacturing quality of the apparatus can be significantly improved.

The individual main components of the apparatus, such as the process chamber, the optical module, a lifting apparatus and a construction cylinder, can be mounted separately from one another and preferably directly on the base element. Preferably, the mounting is designed to allow thermal expansion of the individual components without introducing significant forces into the base element, so that deformation of the main components is freely possible within predetermined tolerance ranges without thereby introducing forces or deformations into the other main components or the base element.

For example, the support points of the main components can be reduced for this purpose so that they are each mounted, for example, only at their own bearing point on the base element, so that the body of the tethered main component introduces no or only minimal forces into the base element in the event of thermal deformation. In addition, it is possible to design the bearing points of the main components accommodated in such a way that a clearance is provided, in particular in the vertical direction, in such a way that no forces are introduced into the base element in the event of thermal expansion in the vertical direction of the tethered main component. In particular, by arranging the individual main components separately on the same basic element, the mutual thermal and mechanical influence of the main components can be minimized, so that the quality of the component part to be produced can be improved.

At least one of the main components, such as the process chamber, the optical module, the lifting apparatus and/or the construction cylinder can be mounted on the base element in a thermally decoupled manner. A thermally decoupled mounting on the base element can be achieved, for example, by using component parts made of thermally insulating materials. In particular, thermally insulating plates and discs, for example made of ceramics or glass or fiber-reinforced plastics, can be used as intermediate elements at the bearing points or junctions. In addition, spacer plates made of thermally insulating plastic can be used. Through this advantageous embodiment, the thermal influence on the basic element can be further reduced. The influence of the main components on each other can also be significantly reduced as a result. In particular, the thermal deformation of the process chamber is essential, so that it is particularly preferred that at least the process chamber is mounted via thermally insulating materials, such as ceramic plates or plastic discs at (preferably each of) the at least one bearing point or junction.

A cooling apparatus may also be provided at the second junction for cooling the junction. The second junction is the (one or more) junction of the process chamber with the base element, which is separate from the first junction. For example, cooling channels may be provided in bearing plates or support plates, which allow active cooling or temperature control of the second junction (or second junctions), thereby minimizing or actively influencing the thermal impact of the process chamber on the base element and the other main components. Passive cooling is also possible, so that, for example, cooling fins can be provided for cooling the second junction (or second junctions), and therefore contribute to reducing the thermal influence of the process chamber on the base element.

Preferably, the main components of the apparatus can be thermally and mechanically decoupled from the process chamber. In particular, the main components of the apparatus can be provided separately from the process chamber on the base element. In particular, one or more adapter elements can also be provided between the optical module and the process chamber for gas-tight and/or laser-safe shielding from the environment. The adapter element is preferably arranged above the process chamber and below the optical module. Since an adapter element is provided as an intermediate element between the optical module and the process chamber and the adapter element can be designed in particular flexibly and enables gas-tight shielding of the transmission area from the optical module to the process chamber, a flexible connection can be achieved as well as decoupling of the optical module from the process chamber in a thermal and mechanical manner. Preferably, the adapter element is directly connected to the optical module and directly connected to the process chamber. Thus, even a strong heating of the process chamber does not lead to an influence on the optical module. Advantageously, the adapter element is connected to the process chamber in such a way that relative movement between the process chamber and the adapter element is permitted in a horizontal plane as well as in a vertical plane. For this purpose, sealing rings and/or membranes can be provided at the connection. By using a displaceable bearing (preferably in a horizontal direction as well as in a vertical direction) combined with sealing rings and/or membranes, a relative movement of the connected process chamber can be released. Deformations of the process chamber are thus not transferred to the optical module via the adapter element but are compensated in a gas-tight and/or laser-safe manner by the specific connection of the adapter element. The mutual thermal and mechanical influence of the components can be minimized, so that the manufacturing quality of the component part can be significantly improved.

Particularly advantageous is the flexible design of the adapter element, so that a relative movement of the process chamber to the optical module free of mechanical stresses can be achieved. For this purpose, the adapter element can, for example, have a telescope-like structure and/or be made of flexible materials. In particular, the adapter element comprises at least one membrane and/or at least one sealing ring to enable mechanical and thermal decoupling from the process chamber and/or the optical module.

Particularly preferably, the adapter element has an integrated protective glass to protect the optical module from the process atmosphere of the process chamber, which is contaminated with particles. Particularly preferably, the protective glass is rigidly connected to the optical module in order to prevent relative displacement of the protective glass with respect to the optical module and thereby ensure precision in the manufacture of the component part. Particularly preferably, the adapter element is provided between the optical module and the process chamber and in communication with the optical module and the process chamber.

The individual main components can have a common reference plane. The individual main components can be aligned with each other via the common reference plane, in particular by means of positioning elements made of temperature-invariant material. A temperature invariant material is, for example, invar or fiber reinforced plastics, such as carbon fiber reinforced or glass fiber reinforced plastics. For example, ceramics or glass can also be used. Due to the fact that all individual main components have a common reference plane, the determination of the position and displacement as well as orientation of the main components can be carried out with respect to a common reference plane, so that a position and orientation determination of the main components is precisely enabled and wherein, for example, a compensation of displacements with respect to the reference plane can be effected via the machine control and thus by adjusting the beam path. To enable the position and orientation of the main components to be determined as accurately as possible, the relative position of the individual main components to the common reference plane can also be carried out relative to the positioning elements provided for the respective main components. Since the positioning elements are made of temperature invariant material and these are directly connected to the common reference plane, the positioning elements behave essentially temperature invariant. Consequently, the individual positioning elements provide reference points or a reference scale for metrological determination of the position and orientation of the individual main components. Thus, a displacement or orientation of the main components can be determined in a simple and reliable manner by determining the relative position and orientation with respect to the positioning element. Preferably, the positioning elements extend from the common reference plane at the top of the base element vertically downward into the apparatus, to the process chamber and to the lifting apparatus and/or the construction cylinder.

At least one of the main components can advantageously be coupled to the common reference plane by means of a positioning element for determining deviations in the orientation or positioning of the respective component. The positioning element can advantageously be provided directly at the common reference plane and extend to the respective main component. The connection point between the main component and the positioning element can be used for metrological determination of position and orientation changes of the main components. Advantageously, a precise determination of the position and orientation of the main component to the common reference plane can be achieved in this way.

The displacement of the main components can be recorded electronically via measuring means and calculated directly and/or simultaneously in the machine control system. Thus, the determined displacement, in particular adjustment of the beam path of the optical module, can be compensated in order to improve the manufacturing quality of the component part.

The individual main components can, at least in part, be directly mechanically connected to the common reference plane via positioning elements for setting a constant distance to the common reference plane. This further development makes it possible, for example, to fix or position floatingly mounted main components via the positioning elements consisting of thermally invariant material so that, for example, a constant distance can always be achieved in the vertical direction between the common reference plane and the connection point between positioning element and main component. The floating bearing in turn allows the main component to expand while the connection point to the positioning element remains as a fixed point. The connection point to the positioning element is selected in particular so that a displacement of the main component has as little effect as possible on the component quality of the component part to be manufactured.

The common reference plane can advantageously be the reference plane of the optical module. This particularly advantageous definition of the reference plane enables simple and efficient determination of the position and orientation of the main components and exact compensation.

Particularly advantageously, the base element is designed in such a way that it forms a rack which encloses the process chamber (in particular completely). This enables a particularly advantageous mounting of the main components and in particular of the process chamber on the base element. In addition, thermal expansions can be compensated by the base element, at least up to a predeterminable maximum value.

Advantageously, the apparatus can have at least one coater for preparing the powdered material. The coater can comprise an alignment apparatus. To maintain the position and orientation of the alignment apparatus constant, it can be directly connected to the reference plane by positioning elements, particularly preferably mechanically. The positioning elements can be designed as rods, bars or thin beams, which are made of temperature invariant material (as already described). This particularly advantageous design makes it possible to keep the distance between the alignment apparatus and the common reference plane essentially constant and thus essentially independent of thermal expansions. Thus, a high component accuracy can be achieved in a particularly efficient manner. Preferably, the positioning elements are oriented along the Z-axis so that a change in length along the Z-axis is prevented as far as possible.

Advantageously, the apparatus can comprise a measuring system of the Z-axis, whereby for constant maintenance of the position and orientation of the measuring system, it can be directly connected to (or mounted on) the reference plane by positioning elements. The measuring system can also be provided as a measuring system of the lifting apparatus.

Advantageously, process monitoring systems such as, in particular, a camera system, a powder bed monitoring system and/or a melting point monitoring system can be provided, each of which is coupled to the common reference plane (preferably directly connected to the reference plane). Advantageously, these additional process monitoring systems are thus arranged independently of the process chamber and are directly connected to or mounted on the basic element.

Advantageously, a method for manufacturing objects by means of an apparatus as aforesaid is proposed, which method may comprise the step of determining the position and/or orientation of at least one main component relative to a common reference plane by means of at least one positioning element. Thus, a particularly accurate manufacture of the object can be achieved.

In addition, the process can include the step of compensating for displacements determined directly or simultaneously by the machine control system by adjusting the beam path (in particular the optical module). Thus, a particularly accurate production of the object can be achieved.

The method may further comprise the step of determining the position and/or orientation of the main components, using the individual main components and the positioning elements associated therewith as a reference. As already described, the positioning elements made of thermally invariant material are to be regarded as fixed points relative to the common reference plane and thus enable simple and obvious detection of the position and orientation of the respective main component by determining the relative distance (or change in distance) of the main component to the respective positioning element.

In a further advantageous embodiment, the process chamber can be released along a release direction at the junction to the base element, in particular in the vertical direction, and a coupling element can additionally be provided, in particular a coupling rod, which couples the movement along the release direction to a reference plane. The coupling rod can be designed as a positioning element and thus consist of temperature-invariant material. The positioning elements can also be designed as rods, which are directly attached to the common reference plane. The apparatus can also have a lifting apparatus for vertical positioning of a construction panel. In addition, a construction cylinder may be provided for guiding the construction panel. Both the lifting apparatus and the construction cylinder may be mounted directly to the base member. All main components may be provided spaced-apart and independent of the process chamber, particularly on the base element.

Advantageously, the individual main components can be connected to the base element in a decoupled manner and the main components can be aligned with each other via a common reference plane. Advantageously, the process chamber can be mounted separately and independently of the optical module on the base element. In this regard, the process chamber may include a process chamber housing to provide a working space sealed from the environment during the build process.

### BRIEF DESCRIPTION OF THE FIGURES

FIG. 1: shows a cross-sectional view of an additive manufacturing plant;

FIG. 2: shows the arrangement of the coater of the additive manufacturing plant;

FIG. 3: shows another side view of the manufacturing plant during thermal expansion;

FIG. 4: shows another side view of the plant with the positioning element installed;

FIGS. 5a and 5b: shows another manufacturing plant.

### DETAILED DESCRIPTION OF PREFERRED EMBODIMENTS

In the following, embodiments of the present invention are described in detail with reference to exemplary figures. The features of the embodiments may be combined in whole or in part, and the present invention is not limited to the described embodiments.

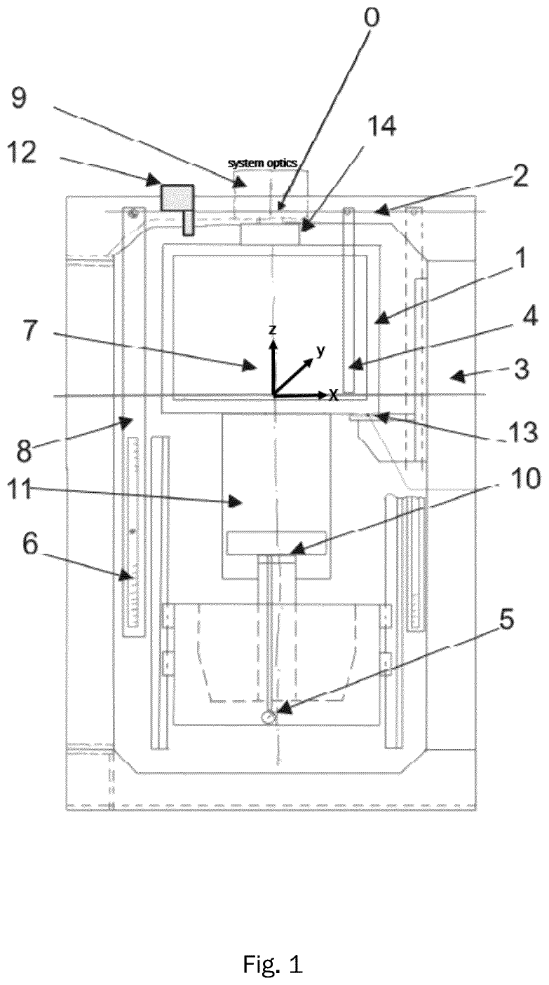

FIG. 1 shows a schematic embodiment of a manufacturing plant based on optical interactions, in particular a manufacturing plant for selective laser melting (SLM system), in which a powder material to be processed is applied in layers to a movable base plate and is locally remelted by means of focused laser irradiation in such a way that a three-dimensional workpiece (object to be manufactured) can be generated by continuous application, exposure to light and melting of further layers of material (additive manufacturing).

For this purpose, the manufacturing plant provides at least one laser light source which generates a light beam via a control system coupled to the manufacturing plant, and this light beam is focused via an optical path onto the material layer to be processed with the aid of various optical elements integrated in a scan head, such as focus or diffuser lenses, mirrors, optical filters, etc. The light beam is then directed onto the material layer to be processed. The manufacturing plant has an optical module 9 for guiding the light beam.

In conventional SLM machines, the problem arises that the main components, such as the optical module, the build chamber (or process chamber), the coater, and the lifting apparatus or the Z-axis are usually directly or at least partially directly connected to or directly attached to the build chamber or the process chamber. This has the disadvantage that when the relative position and/or orientation of the elements change, for example due to thermal expansion or due to mechanical deformation, unwanted changes take place in the overall system, which distort the manufacturing process and thus lead to manufacturing errors, which are due in particular to point positioning errors in the position and orientation of the laser beam in the powder plane. Due to the interaction of the thermal deformation of the main components, which are at least partially directly connected to each other, compensation is only possible with very high effort.

In contrast, the present invention proposes a decoupling of the main components. For example, as shown in FIG. 1, the optical module 9 is mounted directly to the base element 3 at a first junction 0. Separately and spaced-apart therefrom, the process chamber 1 is received directly on the base element 3 at a second junction 13.

For the connection, in particular of the process chamber 1, thermally insulating materials are preferably used, for example ceramic or plastic discs or insulating plates as intermediate elements of the bearing surfaces. The second junction 13 is the junction for connecting the base element 3 to the process chamber 1, which therefore preferably enables a thermally insulating bearing. This enables thermal decoupling of the process chamber 1, which heats up to, for example, 50° C. to 80° C. during operation of the system.

In FIG. 1, a single junction (or bearing point) is shown for the second junction 13, although preferably the process chamber 1 can also be mounted on the base element 3 via several second junctions (preferably via four junctions). These second junctions can be arranged essentially in a horizontal plane, and the process chamber 1 can (preferably exclusively) be placed thereon with its underside firmly connected. The first junction (at which the optical module 9 is mounted) is preferably arranged at a distance (vertically and/or horizontally) from each of the second junctions.

Preferably, the base element 3 has a common reference plane 2, with respect to which the main components are arranged and positioned and whose relative position is used as position information, for example to compensate for deformations. In an advantageous embodiment, the optical module 9 is accommodated directly on this common reference plane 2 (for example directly on the upper side of the basic element 3).

In addition, one or more positioning elements are provided, which extend vertically downward, for example, to the main components. Positioning elements are, for example, positioning elements 4 or 8, which are designed to be thermally and mechanically decoupled from the main components and, in particular, from the process chamber 1, while being fixed to the common reference plane 2. For example, the positioning element 4 can be suspended in the process chamber 1 or arranged laterally thereto to enable efficient position and orientation of the process chamber 1 with respect to the common reference plane 2. Advantageously, the positioning element 4 is not directly connected to the process chamber, but merely functions as a distance scale or relative point for measuring the relative distances. In particular, the process chamber 1, the optical module 9, the lifting apparatus 10 and/or the construction cylinder 11 can be regarded as the main components.

In addition, in order to further improve the accuracy, if thermal displacements nevertheless occur, these displacements can be determined electronically via measuring means and calculated directly and preferably simultaneously in the machine control system. Consequently, additional process monitoring systems 12 can also be provided. These process monitoring systems 12 can preferably be directly connected to the common reference plane and/or fixed thereto. Advantageously, camera systems can be provided for monitoring the equipment, as well as powder bed monitoring systems for monitoring the powder bed and melting point monitoring systems, which in turn are directly coupled to the common reference plane 2, so that they are not subject to thermal and mechanical displacements, and provide accurate and unaltered data.

An adapter element 14 is advantageously provided between the optical module 9 and the process chamber 1. This adapter element 14 allows gas-tight and laser-tight shielding from the environment to be realized, so that optimum forwarding of the laser beam from the optical module 9 into the process chamber 1 is ensured. In this context, the adapter element 14 is flexibly designed or connected so that it is possible to achieve relative displacements of the process chamber 1 to the optical module 9 without the transmission of mechanical stresses. The relative movement with simultaneous sealing can be realized by diaphragms or sealing rings.

The adapter element 14 is connected to the process chamber 1 at a junction in such a way that relative movement between the process chamber 1 and the adapter element 14 is permitted in a horizontal plane as well as in a vertical plane. For this purpose, a plurality of sealing rings and/or diaphragms may be provided at the junction. By using a sliding bearing (preferably both in a horizontal direction and in a vertical direction) combined with sealing rings and/or membranes, a relative movement of the connected process chamber 1 can be released, while ensuring tightness. Deformations of the process chamber 1 are thus not transferred to the optical module 9 by the adapter element 14, but are compensated in a gas-tight and/or laser-safe manner by the specific connection of the adapter element 14. The mutual thermal and mechanical influence of the components can be minimized, so that the manufacturing quality of the component part can be significantly improved.

Furthermore, a protective glass can be integrated in the adapter element 14 to protect the optical module from the particle-contaminated process atmosphere in the process chamber 1. However, the protective glass must be rigidly connected to the optical module 9 to prevent relative displacement of the protective glass relative to the optical module.

FIG. 1 also shows a measuring system 6 that can be used to measure the Z-axis 7 and uses a positioning element 8 as a reference. Furthermore, the measuring system 6 can also be used to determine the position and orientation of main components, for example the construction cylinder 11 and the process chamber 1. The measuring system and preferably all measuring systems of the apparatus are referenced to the common reference plane 2, in particular via positioning elements. By using the positioning element 8 as a reference element, an accurate position and attitude determination of the main components can be achieved. The positioning element is made of temperature invariant material. A temperature invariant material is, for example, invar or fiber reinforced plastics, such as carbon fiber reinforced or glass fiber reinforced plastics.

The construction cylinder 11 contains the lifting apparatus 10, which is vertically movable, for example, to raise or lower a base plate relative to the circumferential conversion. To start a build process, a layer of material powder is deposited and leveled on the plate by means of an alignment apparatus (or a coater 22). During the forming process, after successive application of the layers and merging of the desired sections, the lifting apparatus 10 gradually lowers to allow a new application of a material powder layer at the construction field each time.

As shown in FIG. 1, the further measuring means 5 is also provided, which can detect the relative position of the lifting apparatus 10. Displacements are determined here in the vertical direction, for example. Parallel to this, the positioning elements 8 can be provided laterally to the measuring means 5, for determining a relative positioning of the individual main components and the position or zero point of the measuring system 5. The positioning elements 8 are thereby preferably directly connected to the common reference plane 2. Since the positioning elements are made of thermally invariant material, they essentially do not form due to thermal influences, but remain constant in length. The distance between the positioning elements and the common reference plane 2 can thus be regarded as essentially constant. The measuring means 5 is provided for determining the position and orientation of the forming platform of the lifting apparatus 10. For this purpose, the measuring means 5 may be present, for example, in or parallel to the lifting apparatus 10. In addition, the measuring means 5 can have a positioning element which is arranged within the cylinder of the lifting apparatus 10 in order to provide a constant reference for the position determination. In particular, laser distance sensors can be used as measuring means 5, or tactile measuring apparatuses such as a touch sensor can be used.

Each of the positioning elements provides fixed points with respect to the common reference plane, and these fixed points are used to easily determine the displacement and/or orientation change of each main component. Similar to using a ruler or scale fixed to the common reference plane 2, it is therefore possible to determine a displacement with respect to the common reference plane 2 by measuring or determining the relative position change between a main component and the positioning element, and to use the determined displacement via the machine control system to compensate for the beam path in order to achieve the most accurate component accuracy possible when manufacturing the workpiece.

As shown in FIG. 1, two positioning elements 8 are arranged laterally and spaced-apart from the process chamber 1, whereby these positioning elements can be used, for example, to determine the position of the lifting apparatus 10 and/or the cylinder 11, but also to determine the position of the process chamber 1. By providing two spaced-apart and parallel positioning elements 8, the position of main components can be determined on two different sides, so that a change in position and also a change in orientation can be determined easily and precisely.

The process chamber 1 is firmly connected to the base element 3 at the second junction 13. As can be seen from FIG. 1, however, thermal deformation of the process chamber 1 can lead to a displacement of the center of the process chamber 1 relative to the common reference plane 2. At least one (preferably two) positioning element 4 is also provided for the process chamber 1. The positioning elements are designed to be thermally and mechanically decoupled from the process chamber 1. When the position of the process chamber 1 changes, the fixed points of the positioning element 4 can be used to determine the exact position and orientation of the process chamber 1.

As shown in FIG. 1, the base element 3 can advantageously comprise a base plate or a base element, side walls which are placed on the base plate, and a lid section to which the optical module 9 is attached. Preferably, the component parts of the base element 3 are firmly connected to each other to form a stable rack.

Thus, it is proposed to provide the process chamber 1 as a closed rack or base element 3 that houses or supports all of the main components. The individual components typically include an optical system with the optical module 9, the process chamber 1 or build chamber, a lifting apparatus 10, and the construction cylinder 11. This specific design results in a self-contained force flow and no component is influenced by another component with regard to the application of force. Furthermore, the components can be precisely aligned with each other.

In addition, a plane is defined as a common reference plane 2 for the entire system. Advantageously, this is the reference plane of the optical system or the optical module 9. The accuracy-determining elements, such as main components, are coupled directly and thermally stable to this plane. Thermal stability can be achieved by positioning elements that have a low coefficient of thermal expansion, for example made of Invar. Particularly preferably, the position and orientation of the optical module 9 relative to the reference plane 2 (and the receiving element 3) can also be adjustable, for example by means of a vertically and/or horizontally adjustable bearing.

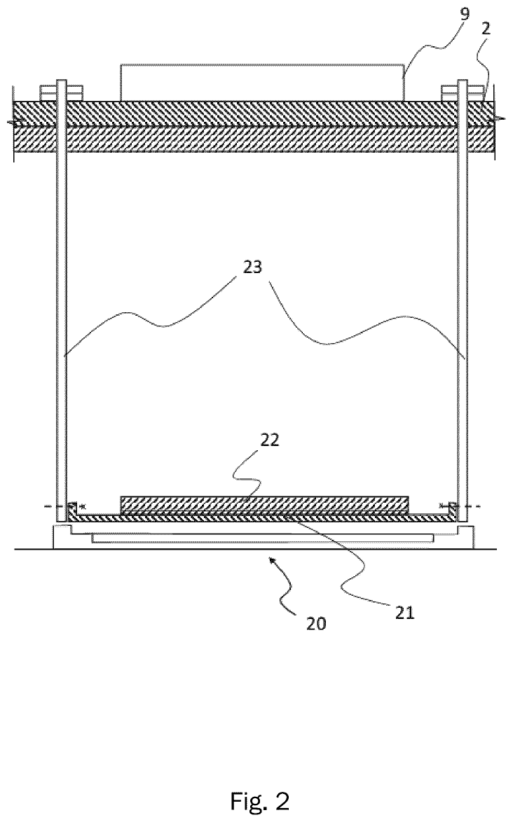

FIG. 2 is an advantageous embodiment of the present invention, which can be used separately or in combination with the embodiment shown in FIG. 1. Shown in FIG. 2 is an alignment apparatus or powder layer preparation unit. This alignment apparatus can be considered as an accuracy determining component or also as a main component. The alignment apparatus with the scraper lip 20 of the coater 22 is part of the powder layer preparation unit, which can be used to level the material powder on the base plate (or construction panel). To align the scraper lip 20, it moves over a straight alignment beam 21. The fastening of the lip is released and the lip can be pressed against the alignment beam 21. In the process, the geometric position, location and orientation of the alignment beam 21 are transferred to the scraper lip 20. The fastening of the scraper lip 20 is then reactivated. The lip is thus rigid again. It is now important that the position of the alignment beam 21 does not change during operation of the machine, so that the scraper lip 20 can always be aligned to it in a reproducible and error-free manner. Errors in the alignment become directly noticeable in a faulty powder coating during the buildup process of the workpiece.

Accurate maintenance of the position and orientation of the alignment beam 21 is achieved by the alignment beam 21 being connected on two sides via positioning elements 23 fixed thereto, and the positioning elements 23 are in turn directly connected to or mounted on the common reference plane 2. Moreover, the positioning elements 23 are made of a material having a low coefficient of thermal expansion. Thus, the positioning elements 23 are particularly made of temperature invariant material. A temperature invariant material is, for example, invar or fiber reinforced plastics, such as carbon fiber reinforced or glass fiber reinforced plastics.

Another accuracy-determining component is the measuring system of the Z-axis 7. Here, too, thermal displacement would lead to incorrect measurements, which in turn can have a direct influence on the accuracy and metallurgical integrity of the component part to be produced. This is avoided by directly connecting the measuring system to the common reference plane 2 via the positioning elements 8 (or at least partially supporting it at the positioning elements). Ideally, the positioning elements are also made here from a material with a low coefficient of thermal expansion.

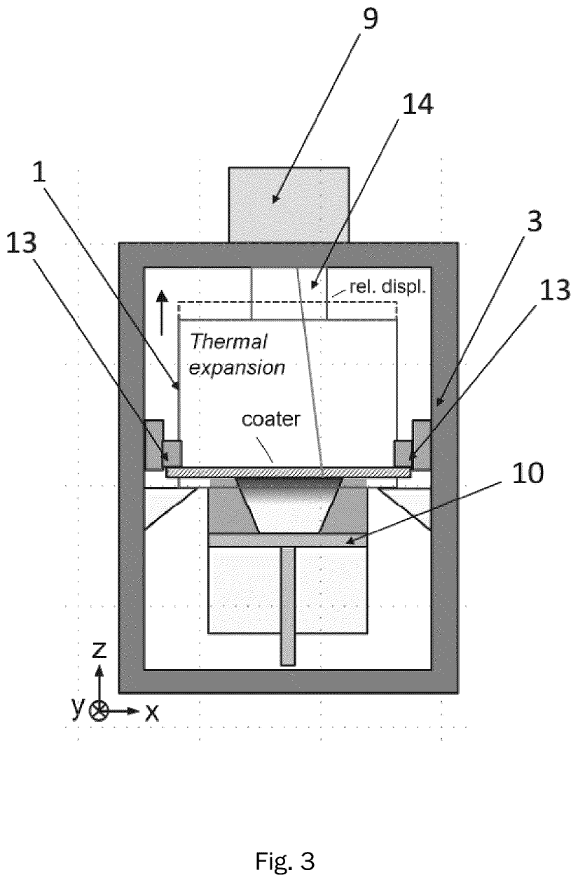

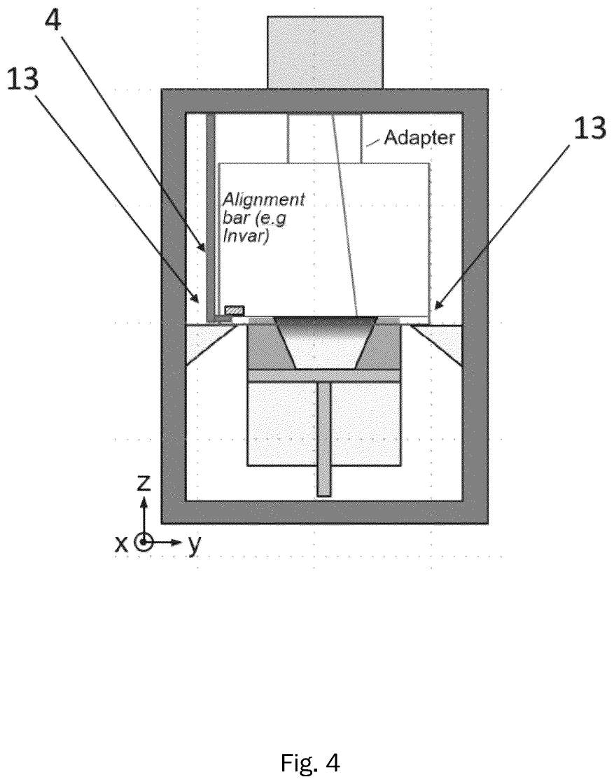

FIGS. 3 and 4 show further embodiments of the present invention, with FIG. 3 showing the thermal expansion of the process chamber 1. By mounting the process chamber 1 at the second junctions 13 on the base element 3, whereby these are only present on the underside, expansion of the process chamber 1 in the vertical direction can be made possible without introducing stresses into the base element 3. The flexibly connected adapter element 14 enables expansion in the horizontal and vertical direction of the top side of the process chamber 1 without inducing stresses in the base element 3 or the optical module.

In FIG. 3, the adapter element 14 is thus provided, which enables decoupling between the optical module 9 and the process chamber 1, whereby the optical module 9 and the process chamber 1 are each mounted on the base element. Thus, precise beam guidance from the optical module 9 can be achieved even in the event of thermal expansion of the process chamber 1.

To further improve the accuracy, as shown in FIG. 4, the positioning element can additionally be provided made of temperature invariant material, which enables an exact position and orientation determination of the main components and in particular of the process chamber 1. A temperature invariant material is, for example, invar or fiber reinforced plastics, such as carbon fiber reinforced or glass fiber reinforced plastics. For example, ceramics or glass can also be used.

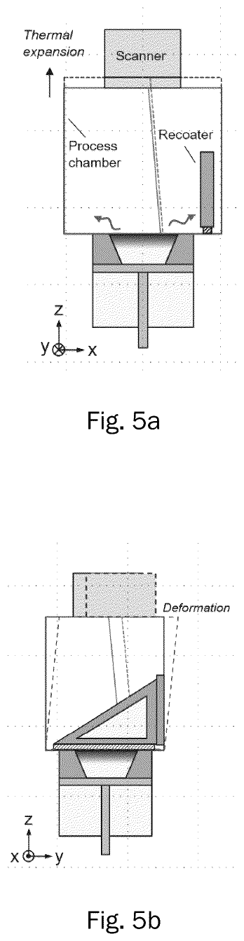

FIGS. 5a and 5b show another manufacturing plant. FIG. 5a shows a process chamber which expands thermally due to the process heat. Since decoupling of the main components is not provided, the focus of the laser beam shifts. FIG. 5b shows that the deformation occurs not only in the vertical direction, but also in the horizontal direction, and therefore complex displacement of the laser beam. The thermal and mechanical deformation leads to a significant inaccuracy in the component manufacturing.

1. Apparatus for forming objects from powdery material layer by layer by means of optical interaction, wherein the apparatus comprises:
a process chamber for providing a working space in the area of a construction field,
at least one optical module of an irradiation unit for spatially selective irradiation of the material present in the region of the construction field,
a lifting apparatus for vertically positioning a construction panel to support the construction field, and
a collective receiving element for joint connection of individual main components of the apparatus, wherein
the optical module is arranged on the receiving element at a first junction and the process chamber is arranged separately from the optical module at, at least one spaced-apart second junction on the receiving element.

2. Apparatus according to claim 1, wherein
the individual main components including at least one of the process chamber, the optical module, the lifting apparatus and/or a construction cylinder are mounted separately from one another and directly on the receiving element.

3. Apparatus according to claim 1, wherein
at least one of the main components including the process chamber, the optical module, the lifting apparatus and/or the construction cylinder is mounted on the receiving element in a thermally decoupled manner.

4. Apparatus according to claim 1, wherein
a cooling unit for cooling the junction is provided at least at the second junction.

5. Apparatus according to claim 1, wherein
the process chamber is mounted at only one bearing point on the receiving element and/or wherein all function carriers are mounted separately from the process chamber.

6. Apparatus according to claim 1, wherein
the main components of the apparatus are thermally and mechanically decoupled from the process chamber, and an adapter element is provided between the optical module and the process chamber for gas-tight and/or laser-safe shielding of a beam guiding region from the environment.

7. Apparatus according to claim 1, wherein
the adapter element is flexibly designed so that a relative displacement of the process chamber to the optical module free of mechanical stresses becomes possible.

8. Apparatus according to claim 1, wherein
the adapter element comprises a membrane and/or a sealing ring.

9. Apparatus according to claim 1, wherein
the adapter element comprises an integrated protective glass to protect the optical module from the process atmosphere contaminated with particles, and wherein the protective glass is rigidly connected to the optical module to avoid relative displacements of the protective glass to the optical module.

10. Apparatus according to claim 1, wherein
the individual main components have a common reference plane and the individual main components are aligned with respect to one another via the common reference plane.

11. Apparatus according to claim 1, wherein
at least one of the main components is coupled to the common reference plane by means of a positioning element for determining deviations in the orientation or positioning of the respective component.

12. Apparatus according to claim 1, wherein
displacements of the main components are electronically determined via measuring means and are calculated directly and/or simultaneously in the machine control in order to compensate for the determined displacements.

13. Apparatus according to claim 1, wherein
the individual main components are at least partially directly mechanically connected to the common reference plane via positioning elements for setting a constant distance to the common reference plane.

14. Apparatus according to claim 1, wherein
the reference plane of the optical module is the common reference plane.

15. Apparatus according to claim 1, wherein
the receiving element is a rack that encloses at least the process chamber and wherein the receiving element also encloses the lifting apparatus and/or the construction cylinder.

16. Apparatus according to claim 1, wherein
the apparatus further comprises a coater for preparing the powdered material, and the coater comprises an alignment apparatus, and wherein,
in order to maintain the position and orientation of the alignment apparatus constant, it is directly connected to the common reference plane by positioning elements.

17. Apparatus according to claim 1, wherein
the apparatus comprises a measuring system of the Z-axis, and for constant maintenance of the position and orientation of the measuring system, the latter is directly connected to the common reference plane by positioning elements.

18. Apparatus according to claim 1, wherein
process monitoring systems including at least one of a camera system, a powder bed monitoring system, and/or a melting point monitoring system are provided, which are each coupled to the common reference plane.

19. Method of manufacturing objects by means of a device according to claim 1, wherein
the position and/or orientation of at least one main component relative to the common reference plane is determined using a positioning element, and
the detected displacement is compensated directly and/or simultaneously by the machine control system by adjusting the beam path of the optical module.

20. Method according to claim 19, wherein
to determine the position and orientation of the main components, the positioning elements associated with each main component is used as a reference.
